(19) United States
(12) Patent Application Publication
(10) Pub. No.: US 2026/0279351 A1
(43) Pub. Date: Sep. 17, 2026

(54) SELF IMPROVE VOICE CONTROL INTERNET OF THINGS DEVICE

(71) Applicant: Microchip Technology Inc., Chandler, AZ (US)

(72) Inventor: Tik Man Lee, Chandler, AZ (US)

(73) Assignee: Microchip Technology Inc., Chandler, AZ (US)

(21) Appl. No.: 19/195,948

(22) Filed: May 1, 2025

Related U.S. Application Data
(60) Provisional application No. 63/771,947, filed on Mar. 14, 2025.

(51) Int. Cl. G10L 15/22

(52) U.S. Cl. CPC G10L 15/22; G10L 2015/223

(57) ABSTRACT

A method processes digital voice data having a command via a first artificial intelligence recognition model, processes the digital voice data via a second artificial intelligence recognition model, compares the processing via the first artificial intelligence recognition model and the processing via the second artificial intelligence recognition model, and prioritizes either the first or the second artificial intelligence recognition model based on the comparison. A system has a memory having instructions in the memory, a processor circuit to execute the instructions to: process digital voice data comprising a command via a first artificial intelligence recognition model, process the digital voice data via a second artificial intelligence recognition model, compare the processing via the first artificial intelligence recognition model and the processing via the second artificial intelligence recognition model, and prioritize either the first or the second artificial intelligence recognition model based on the comparing.

### CROSS-REFERENCE TO RELATED APPLICATIONS

This application claims priority to U.S. Provisional Patent Application No. 63/771,947, filed Mar. 14, 2025, which is hereby incorporated by reference in its entirety as if fully set forth herein.

### TECHNICAL FIELD

The present disclosure relates to voice recognition software, in particular, artificial intelligence recognition models to recognize voice commands and trigger actions.

### BACKGROUND

Devices have a microphone to receive voice input. The device processes the voice input by filtering and converting from analog to digital data. A voice recognition artificial intelligence model (for example, sensory) may then process the voice data. The device may then provide control commands via a control board.

For example, some devices use a wake word to initiate a voice command: “Hey Google”, “Hey Siri”, or “Alexa”. The wake word may be followed by an action keyword to clearly state what the user wants to do: “open”, “play”, “select”, “search”, or “turn on”, without limitation. The action keyword may be followed by a target element to specify what the user would like the device to interact with, such as an application, a file, a setting, or a specific piece of information. Thus, voice instructions are typically formatted: [wake word][action keyword][target element]. For example, a user may provide a voice instruction: [Hey Google][power on][the light].

However, edge voice control devices have poor accuracy.

There is a need for voice control Internet of Things devices to improve its accuracy in usage, in particular, improve the voice control accuracy of a device after shipment.

### SUMMARY

According to aspects, there is provided a method comprising: processing digital voice data comprising a command via a first artificial intelligence recognition model; processing the digital voice data via a second artificial intelligence recognition model; comparing the processing via the first artificial intelligence recognition model and the processing via the second artificial intelligence recognition model; and prioritizing either the first or the second artificial intelligence recognition model based on the comparing.

Aspects as in the previous paragraph provide a method, wherein the first artificial intelligence recognition model comprises a model selected from natural language processing, hidden Markov, N-grams, speaker diarization, and dynamic time warping, wherein the second artificial intelligence recognition model comprises a model selected from natural language processing, hidden Markov, N-grams, speaker diarization, and dynamic time warping.

Aspects as in one of the preceding two paragraphs provides a method, wherein the processing via the first artificial intelligence recognition model comprises repeatedly attempting to recognize the command in the digital voice data, and wherein the processing via the second artificial intelligence recognition model comprises repeatedly attempting to recognize the command in the digital voice data.

Aspects as in one of the preceding three paragraphs provides a method, wherein the analog voice input comprises a plurality of commands, wherein processing via the first artificial intelligence recognition model comprises attempting to recognize respective ones of plurality of commands in the digital voice data, and wherein processing via the second artificial intelligence recognition model comprises attempting to recognize respective ones of plurality of commands in the digital voice data.

Aspects as in one of the preceding four paragraphs provides a method, wherein the processing via the first artificial intelligence recognition model comprises recognizing the command in the digital voice data and triggering an action when the command is recognized by the first artificial intelligence recognition model, and wherein the processing via the second artificial intelligence recognition model comprises recognizing the command in the digital voice data and triggering the action when the command is recognized by the first artificial intelligence recognition model.

Aspects as in one of the preceding five paragraphs provides a method, wherein comparing the processing via the first artificial intelligence recognition model and the processing via the second artificial intelligence recognition model comprises comparing a first number of actions triggered by the first artificial intelligence recognition model and a second number of actions triggered by the second artificial intelligence recognition model.

Aspects as in one of the preceding six paragraphs provides a method, wherein comparing the processing via the first artificial intelligence recognition model and the processing via the second artificial intelligence recognition model comprises comparing a first number of attempts to recognize the command by the first artificial intelligence recognition model and a second number of attempts to recognize the command by the second artificial intelligence recognition model.

Aspects as in one of the preceding seven paragraphs provides a method, wherein the analog voice input comprises a plurality of commands, wherein comparing the processing via the first artificial intelligence recognition model and the processing via the second artificial intelligence recognition model comprises comparing a first number of recognized commands by the first artificial intelligence recognition model and a second number of recognized commands by the second artificial intelligence recognition model.

Aspects as in one of the preceding eight paragraphs provides a method, wherein prioritizing either the first or the second artificial intelligence recognition model based on the comparing comprises giving command control of a target element to either the first or the second artificial intelligence recognition model.

Aspects as in one of the preceding nine paragraphs provides a method, comprising: weighting a first attempt to recognize the command by the first artificial intelligence recognition model with a first weight; and weighting a second attempt to recognize the command by the first artificial intelligence recognition model with a first weight, wherein the first and second weights are different.

According to aspects, there is provided a system comprising: a memory having instructions in the memory; a processor circuit to execute the instructions to: process digital voice data comprising a command via a first artificial intelligence recognition model; process the digital voice data via a second artificial intelligence recognition model; compare the processing via the first artificial intelligence recognition model and the processing via the second artificial intelligence recognition model; and prioritize either the first or the second artificial intelligence recognition model based on the comparing.

Aspects as in the previous paragraph provide a system, wherein the first artificial intelligence recognition model comprises a model selected from natural language processing, hidden Markov, N-grams, speaker diarization, and dynamic time warping, wherein the second artificial intelligence recognition model comprises a model selected from natural language processing, hidden Markov, N-grams, speaker diarization, and dynamic time warping.

Aspects as in one of the previous two paragraphs provides a system, wherein the instructions are to: process via the first artificial intelligence recognition model by repeatedly attempting to recognize the command in the digital voice data, and process via the second artificial intelligence recognition model by repeatedly attempting to recognize the command in the digital voice data.

Aspects as in one of the previous three paragraphs provides a system, wherein the voice data comprises a plurality of commands, wherein the instructions are to: process via the first artificial intelligence recognition model by attempting to recognize respective ones of plurality of commands in the digital voice data, and process via the second artificial intelligence recognition model by attempting to recognize respective ones of plurality of commands in the digital voice data.

Aspects as in one of the previous four paragraphs provides a system, wherein the instructions are to: process via the first artificial intelligence recognition model by recognizing the command in the digital voice data and triggering an action when the command is recognized by the first artificial intelligence recognition model, and process via the second artificial intelligence recognition model by recognizing the command in the digital voice data and triggering the action when the command is recognized by the first artificial intelligence recognition model.

Aspects as in one of the previous five paragraphs provides a system, wherein the instructions are to: compare a process via the first artificial intelligence recognition model and a process via the second artificial intelligence recognition model by comparing a first number of actions triggered by the first artificial intelligence recognition model and a second number of actions triggered by the second artificial intelligence recognition model.

Aspects as in one of the previous six paragraphs provides a system, wherein the instructions are to: compare a process via the first artificial intelligence recognition model and a process via the second artificial intelligence recognition model by comparing a first number of attempts to recognize the command by the first artificial intelligence recognition model and a second number of attempts to recognize the command by the second artificial intelligence recognition model.

Aspects as in one of the previous seven paragraphs provides a system, wherein the voice data comprises a plurality of commands, wherein the instructions are to: compare a process via the first artificial intelligence recognition model and a process via the second artificial intelligence recognition model by comparing a first number of recognized commands by the first artificial intelligence recognition model and a second number of recognized commands by the second artificial intelligence recognition model.

Aspects as in one of the previous eight paragraphs provides a system, wherein the instructions are to: prioritize either the first or the second artificial intelligence recognition model based on compare a process via the first artificial intelligence recognition model and a process via the second artificial intelligence recognition model; and give command control of a target element to either the first or the second artificial intelligence recognition model.

Aspects as in one of the previous nine paragraphs provides a system, wherein the instructions are to: weight a first attempt to recognize the command by the first artificial intelligence recognition model with a first weight; and weight a second attempt to recognize the command by the first artificial intelligence recognition model with a first weight, wherein the first and second weights are different.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 shows a block diagram of components of a handheld device. The device has a microphone to receive voice input.

FIG. 2A shows a block diagram of components of a handheld device and a table to track voice recognition attempts

FIG. 2B shows the table to track voice recognition attempts of FIG. 2A, wherein one trigger has been recorded.

FIG. 2C shows the table to track voice recognition attempts of FIG. 2A, wherein two triggers have been recorded.

FIG. 2D shows the table to track voice recognition attempts of FIG. 2A, wherein ten triggers have been recorded.

FIG. 3 shows a block diagram of components of a handheld device having any number of AI models.

FIG. 4 shows a flow chart of a method to provide more effective voice command recognition by to prioritize control between two artificial intelligence recognition models.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided a device to swap control between two artificial intelligence recognition models.

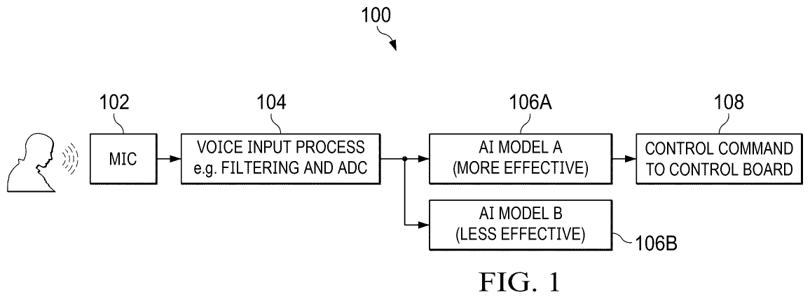

FIG. 1 shows a block diagram of components of a handheld device. The device 100 has a microphone 102 to receive voice or speech input. The device 100 has a filter and analog to digital converter (ADC) 104 to process the voice input by filtering and converting from analog to digital data. The device 100 has two artificial intelligence recognition models 106A and 106B. Both artificial intelligence recognition models A and B 106A and 106B have the ability to provide commands to a control board 108. As shown, artificial intelligence recognition model A 106A has been shown to be more effective, so it is given command priority to the control board 108.

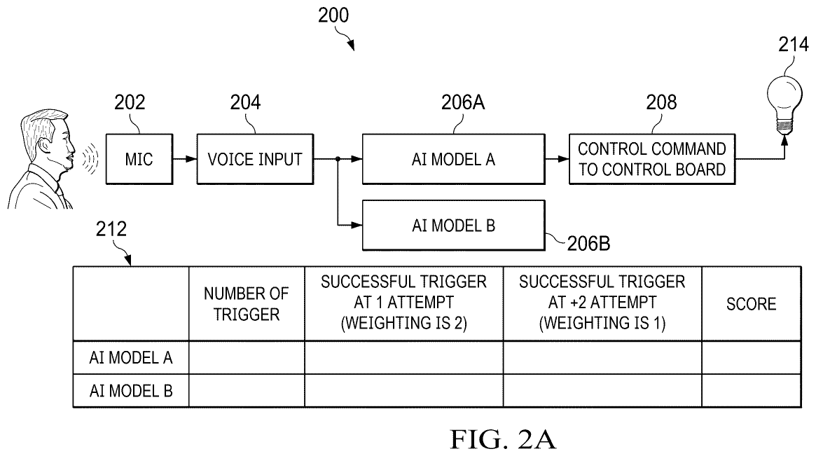

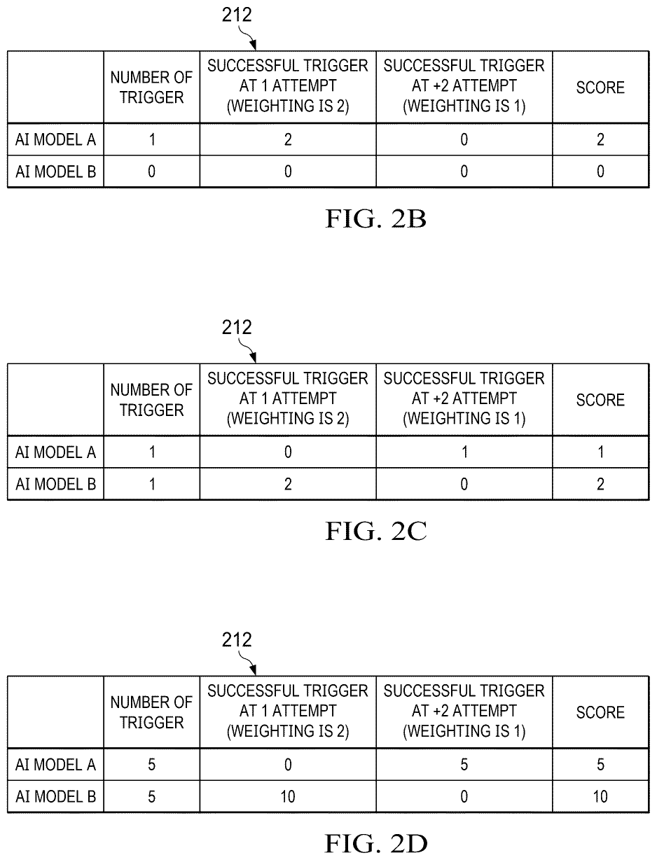

FIG. 2A shows a block diagram of components of a handheld device and a table to track voice recognition attempts. The device 200 has a microphone 202 to receive voice or speech input. The device 200 has a filter and ADC 204 to process the voice input by filtering and converting from analog to digital data. The device 200 has two artificial intelligence recognition models 206A and 206B. Both artificial intelligence recognition models A and B, 206A and 206B, have the ability to provide commands to the control board 208. Both the first and second voice recognition artificial intelligence recognition models A and B, 206A and 206B, attempt to recognize the voice or speech data. The performance of both the AI model A 206A and the AI model B 206B are recorded and compared to determine which one is more effective. In normal behavior, when the device 200 fails to recognize a voice command, the user will try again with the same voice command until the required action has been achieved. By counting the number of attempts to decipher the voice data and the number of successful commands issued (trigger), the voice recognition artificial intelligence recognition models A and B, 206A and 206B, may be scored to determine which is more effective. The counted numbers and scores may be populated in a table 212.

In FIG. 2A, the illustrated device is light 214. In alternative examples, the device may be any device controlled by a controller. For example, Internet of Things devices may include: home security, connected automobiles, lamps and lighting, smart home devices, smart locks, smart thermostats, wearables, smart appliances. Control devices may include smart speakers, such as: Amazon Echo, Google Home, and Apple HomePod. These devices may use Amazon's Alexa, Google Assistant, and Apple's Siri voice assistants.

FIG. 2B shows the table to track voice recognition attempts of FIG. 2A. As shown in table 212, one trigger has been recorded for AI model A. For example, assume a light or lamp 214 is controlled by the device 200. To command the device 200 to turn ON the light 214, the user may say in a first attempt, “[Hey Google] [Power On] [The Light].” The results may be: AI model A turns ON the light, so one trigger is recorded for AI model A. However, AI model B did not decipher the voice command and failed to command the light 214 to turn ON, so no trigger is recorded for AI model B. Because the light is turned ON by the AI model A, the user will stop saying the same command. The device 200 provides the results shown in FIG. 2B. Based on the results, the AI model A is the more effective AI model and may be given control to provide commands to the control board 208. The more effective AI model may be prioritized over AI model B or any number of other models, wherein prioritization may include giving control to provide commands to the control board 208, giving control to recognize certain voice dialects, certain individual persons, certain voice commands, without limitation.

FIG. 2C shows the table 212 to track voice recognition attempts by the device 200 of FIG. 2A. In this example, command control initially resides with AI model A. To command the device 200 to turn ON the light 214, the user may say in a first attempt, “[Hey Google] [Power On] [The Light]”—1^{st} Attempt. The results may be: AI model A does not recognize the command and does not turn ON the light. The system does not record a trigger for AI model A. However, AI model B does correctly recognize the voice data and issues a command to turn ON the light 212. The system records a successful trigger on the first attempt for AI model B, and records and “1” for the number of triggers for AI model B and records a weighted “2” for a successful trigger on the first attempt. However, because AI model A still has command control, the light is still OFF, and the user will try again the same command: [Hey Google] [Power On] [The Light]—2nd Attempt. The result of the second attempt may be: AI model A deciphers the voice data and issues a command to “turn ON the light,” but AI model B also deciphers the voice data and issues a command to “turn ON the light.” The system records a trigger for AI model A, and records a weighted “1” for a successful trigger on the second attempt for AI model A. Because AI model A still had command control, the light is now ON in response to command of AI model A. As the light is ON, the user will not try again the same command. Based on these results, the AI model B has the higher score and is assumed to be the more effective AI model to use and may be given control to provide commands to the control board 208 going forward.

FIG. 2D shows the table 212 to track voice recognition attempts by the device 200 of FIG. 2A according to another example. In this example, ten triggers are recorded. As the user is using the voice control light. A set of data has been built over time. Based on the current result, the AI model B is the more effective AI model to use. The system may employ a pre-defined a rule that when an AI model has a score that is five points higher than another AI model, then the AI model with the higher score is given control to provide commands to the control board 208. As shown in FIG. 2D, AI model A has a score of 5 and AI model B has a score of 10. Thus, according to the pre-defined rule, AI model B will be given control to provide commands to the control board 208.

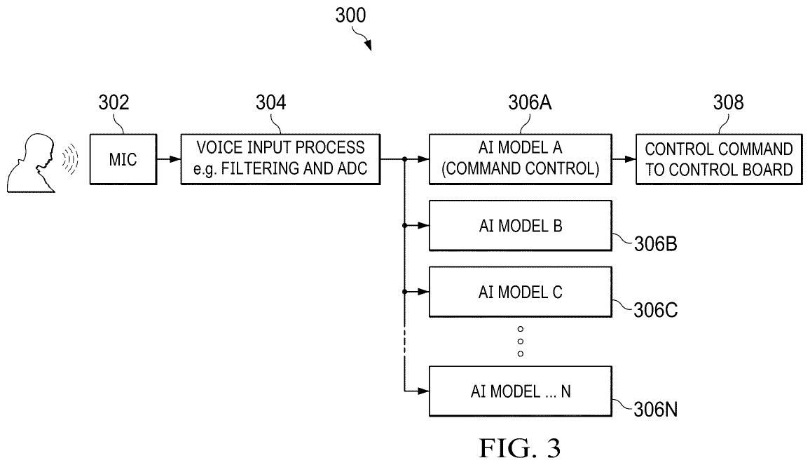

FIG. 3 shows a block diagram of components of a handheld device 300 having any number of AI models 306. The device has a microphone 302 to receive voice input. The device 300 has a filter and ADC 304 to process the voice input by filtering and converting from analog to digital data. The device 300 has a number N of artificial intelligence recognition models 306. The artificial intelligence recognition models A, B, C, . . . N, 306A, 306B, 306C, . . . 306N, have the ability to provide commands to the control board 308. In operation, the artificial intelligence recognition models A, B, C, . . . N attempt to recognize commands in the voice data. The performance of the artificial intelligence recognition models A, B, C, . . . N are recorded and compared to determine which one is more effective at triggering action based on recognized commands. In normal behavior, when the device 300 fails to recognize a voice command, the user will try again with the same voice command until the commanded action is triggered. By counting the number of triggers, the number of successful triggers at a first command attempt, and the number of triggers at a second command attempt, the AI models may be scored to determine which is more effective. The device 300 may give control to provide commands to the control board 208 to the more effective AI model.

A comparison process may be applied to any number N of AI models. Of course, the more AI models being compared, the greater the amount of memory or the faster a high speed MCU may be to process the data. The system may provide more effective performance for speech with different dialects and speech patterns. For example, if a device has five pre-loaded AI models, the more effective AI model of the five may be selected for the user of the device and that more effective AI model may be given control to provide commands to the control board. English is a very “dialectical” language, which may lend to different AI models being more effective for specific dialects.

Example artificial intelligence recognition models include: natural language processing, hidden Markov, N-grams, speaker diarization, and dynamic time warping, without limitation.

Natural language processing (NLP) focuses on the interaction between humans and machines through language through speech and text. NLP models estimate the probability of word sequences in the recognized text, convert colloquial expressions and abbreviations and map phonetic units from acoustic models to words in the target language.

Hidden Markov Models (HMM) are based on the probability of a given state depends on the current state rather than its prior states (Markov chain model). HMM may incorporate hidden events, such as part-of-speech tags, into a probabilistic model. In speech recognition, HMM assign labels to each unit—i.e. words, syllables, sentences, without limitation—in the sequence. Labels map to input so the model may determine the most appropriate label sequence.

N-grams are simple language models (LM), which assign probabilities to sentences or phrases. An N-gram is sequence of N-words. For example, “order the pizza” is a trigram or 3-gram and “please order the pizza” is a 4-gram. Grammar and the probability of certain word sequences are used.

Neural networks (NN) process training data through layers of nodes. Each node is made up of inputs, weights, a bias (or threshold) and an output. If that output value exceeds a given threshold, it “fires” or activates the node, passing data to the next layer in the network. Neural networks learn this mapping function through supervised learning, adjusting based on the loss function through the process of gradient descent.

Speaker diarization (SD) models identify and segment speech by speaker identity. Identification of the speaker may help algorithms distinguish individuals engaged in conversation.

Dynamic time warping (DTW) models measure similarity between two sequences that may vary in time or speed. Speech patterns may be detected even if in one audio the person was talking slowly and if in another he or she were talking more quickly. Dynamic time warping algorithms may recognize speech patterns even if the speaker accelerations and deceleration during the course of one observation. The models “warp” sequences non-linearly to match or align each other.

An artificial intelligence recognition model may comprise a combination of speech recognition techniques and strategies employed by models including: natural language processing, hidden Markov, N-grams, speaker diarization, and dynamic time warping, without limitation.

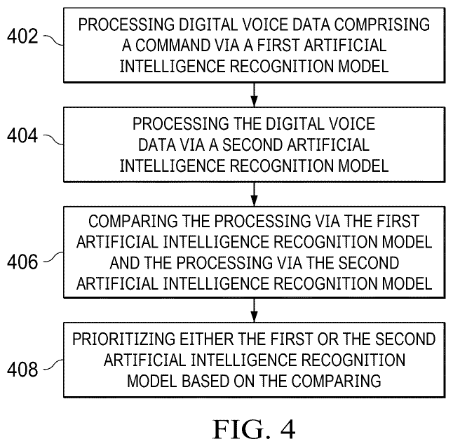

FIG. 4 shows a flow chart of a method to provide more effective voice command recognition by to prioritize control between two artificial intelligence recognition models. Digital voice data is processed 402, wherein the digital voice data comprises a command via a first artificial intelligence recognition model. The digital voice data is processed 404 via a second artificial intelligence recognition model. The processing via the first artificial intelligence recognition model and the processing via the second artificial intelligence recognition model are compared 406. Either the first or the second artificial intelligence recognition model is prioritized 408 based on the comparison.

Although examples have been described above, other variations and examples may be made from this disclosure without departing from the spirit and scope of these disclosed examples.

What is claimed is:

1. A method comprising:
processing digital voice data comprising a command via a first artificial intelligence recognition model;
processing the digital voice data via a second artificial intelligence recognition model;
comparing the processing via the first artificial intelligence recognition model and the processing via the second artificial intelligence recognition model; and
prioritizing either the first or the second artificial intelligence recognition model based on the comparing.

2. The method as in claim 1, wherein the first artificial intelligence recognition model comprises a model selected from natural language processing, hidden Markov, N-grams, speaker diarization, and dynamic time warping, wherein the second artificial intelligence recognition model comprises a model selected from natural language processing, hidden Markov, N-grams, speaker diarization, and dynamic time warping.

3. The method as in claim 1, wherein the processing via the first artificial intelligence recognition model comprises repeatedly attempting to recognize the command in the digital voice data, and wherein the processing via the second artificial intelligence recognition model comprises repeatedly attempting to recognize the command in the digital voice data.

4. The method as in claim 1, wherein the analog voice input comprises a plurality of commands, wherein processing via the first artificial intelligence recognition model comprises attempting to recognize respective ones of plurality of commands in the digital voice data, and wherein processing via the second artificial intelligence recognition model comprises attempting to recognize respective ones of plurality of commands in the digital voice data.

5. The method as in claim 1, wherein the processing via the first artificial intelligence recognition model comprises recognizing the command in the digital voice data and triggering an action when the command is recognized by the first artificial intelligence recognition model, and wherein the processing via the second artificial intelligence recognition model comprises recognizing the command in the digital voice data and triggering the action when the command is recognized by the first artificial intelligence recognition model.

6. The method as in claim 5, wherein comparing the processing via the first artificial intelligence recognition model and the processing via the second artificial intelligence recognition model comprises comparing a first number of actions triggered by the first artificial intelligence recognition model and a second number of actions triggered by the second artificial intelligence recognition model.

7. The method as in claim 1, wherein comparing the processing via the first artificial intelligence recognition model and the processing via the second artificial intelligence recognition model comprises comparing a first number of attempts to recognize the command by the first artificial intelligence recognition model and a second number of attempts to recognize the command by the second artificial intelligence recognition model.

8. The method as in claim 1, wherein the analog voice input comprises a plurality of commands, wherein comparing the processing via the first artificial intelligence recognition model and the processing via the second artificial intelligence recognition model comprises comparing a first number of recognized commands by the first artificial intelligence recognition model and a second number of recognized commands by the second artificial intelligence recognition model.

9. The method as in claim 1, wherein prioritizing either the first or the second artificial intelligence recognition model based on the comparing comprises giving command control of a target element to either the first or the second artificial intelligence recognition model.

10. The method as in claim 1, comprising:
weighting a first attempt to recognize the command by the first artificial intelligence recognition model with a first weight; and
weighting a second attempt to recognize the command by the first artificial intelligence recognition model with a first weight,
wherein the first and second weights are different.

11. A system comprising:
a memory having instructions in the memory;
a processor circuit to execute the instructions to:
process digital voice data comprising a command via a first artificial intelligence recognition model;
process the digital voice data via a second artificial intelligence recognition model;
compare the processing via the first artificial intelligence recognition model and the processing via the second artificial intelligence recognition model; and
prioritize either the first or the second artificial intelligence recognition model based on the comparing.

12. The system as in claim 11, wherein the first artificial intelligence recognition model comprises a model selected from natural language processing, hidden Markov, N-grams, speaker diarization, and dynamic time warping, wherein the second artificial intelligence recognition model comprises a model selected from natural language processing, hidden Markov, N-grams, speaker diarization, and dynamic time warping.

13. The system as in claim 11, wherein the instructions are to:
process via the first artificial intelligence recognition model by repeatedly attempting to recognize the command in the digital voice data, and
process via the second artificial intelligence recognition model by repeatedly attempting to recognize the command in the digital voice data.

14. The system as in claim 11, wherein the voice data comprises a plurality of commands, wherein the instructions are to:
process via the first artificial intelligence recognition model by attempting to recognize respective ones of plurality of commands in the digital voice data, and
process via the second artificial intelligence recognition model by attempting to recognize respective ones of plurality of commands in the digital voice data.

15. The system as in claim 11, wherein the instructions are to:
process via the first artificial intelligence recognition model by recognizing the command in the digital voice data and triggering an action when the command is recognized by the first artificial intelligence recognition model, and
process via the second artificial intelligence recognition model by recognizing the command in the digital voice data and triggering the action when the command is recognized by the first artificial intelligence recognition model.

16. The system as in claim 15, wherein the instructions are to:
compare a process via the first artificial intelligence recognition model and a process via the second artificial intelligence recognition model by comparing a first number of actions triggered by the first artificial intelligence recognition model and a second number of actions triggered by the second artificial intelligence recognition model.

17. The system as in claim 11, wherein the instructions are to:
compare a process via the first artificial intelligence recognition model and a process via the second artificial intelligence recognition model by comparing a first number of attempts to recognize the command by the first artificial intelligence recognition model and a second number of attempts to recognize the command by the second artificial intelligence recognition model.

18. The system as in claim 11, wherein the voice data comprises a plurality of commands, wherein the instructions are to:
compare a process via the first artificial intelligence recognition model and a process via the second artificial intelligence recognition model by comparing a first number of recognized commands by the first artificial intelligence recognition model and a second number of recognized commands by the second artificial intelligence recognition model.

19. The system as in claim 11, wherein the instructions are to:
prioritize either the first or the second artificial intelligence recognition model based on compare a process via the first artificial intelligence recognition model and a process via the second artificial intelligence recognition model; and
give command control of a target element to either the first or the second artificial intelligence recognition model.

20. The system as in claim 11, wherein the instructions are to:
weight a first attempt to recognize the command by the first artificial intelligence recognition model with a first weight; and
weight a second attempt to recognize the command by the first artificial intelligence recognition model with a first weight,
wherein the first and second weights are different.
